(19) United States
(12) Patent Application Publication
(10) Pub. No.: US 2008/0131718 A1
(43) Pub. Date: Jun. 5, 2008

(54) Method Of Producing A Preform For Thermoformed Containers

(75) Inventor: Francis P. Pinsolle, Villefranche/Mer (FR)

Correspondence Address: YOUNG & THOMPSON, 209 Madison Street, Suite 500, ALEXANDRIA, VA, 22314, US

(73) Assignee: Siamp Cedap, Monaco (MC)

(21) Appl. No.: 11/662,405

(22) PCT Filed: Sep. 14, 2005
(86) PCT No.: PCT/FR05/02274

§ 371 Date: May 9, 2007

(30) Foreign Application Priority Data
Sep. 15, 2004 (FR) 0409753

(51) Int. Cl. B29B 11/04; B29B 11/10; B29C 65/02; B29B 11/14

(52) U.S. Cl. 428/542.8; 264/148

(57) ABSTRACT

Method of producing a preform for thermoformed containers, which takes the form of a token. The method includes the following steps: producing the lower part (3) of the token, this step including the extrusion of a cylindrical bar (2) and the cutting of the bar (2) into disks (3); producing the upper part (6) of the token; and assembling the two parts by heat sealing.

The invention relates to a process for producing a preform for heat-formed containers and more particularly a preform that comes in the form of a token.

For the production of containers of curved shape, for example for yogurt, it is known to use heat-forming starting from a preform that consists of a polystyrene token that is approximately 5 mm thick. Such a token is heated, then stretched toward the bottom and heat-formed. It thus is possible to produce containers that are deep enough while avoiding losses of material that consist of clippings. The product that is obtained makes possible the application of the technique that is known under the name of Form-Fill-Seal or FFS, i.e., heat-forming-filling-sealing, of which the advantages are: a single-operation conditioning, a limitation of the risks of contamination of the packaging and a reduction in the costs of production, transport and storage of packaging. Polystyrene is particularly suited to this technology because of its rigidity and its ease of use by heat-forming.

The token is obtained by cutting into an extruded thick sheet. The clippings are large but can be reused because the sheet is homogeneous. This process is suitable for yogurts, for example.

The token, however, is characterized by isotropy that is derived from the natural orientation that is undergone by the sheet during its extrusion. This isotropy, because it is perpendicular to the stretching axis, may play a harmful role during the heat-forming phase of the token.

If the long-term milk packaging is in question, it is necessary to provide in addition a black layer that constitutes a UV barrier. In the case of fruit juice, it is necessary to provide an additional layer that constitutes a barrier to gases or to water vapor.

For this purpose, tokens that consist of a stack of layers of suitable compositions are used. Such multilayer tokens are described in, for example, the patents U.S. Pat. No. 4 790 972, EP 0 533 437, FR 2,009,903, U.S. Pat. No. 5,091,231 and U.S. Pat. No. 4,122,147.

These multilayer tokens are usually cut into a multilayer material that is obtained either by stacking sheets or by co-extrusion of the additional layers with the polystyrene sheet. However, on the one hand, the co-extrusion of thick layers is delicate to control, on the other hand, the clippings cannot be reused because they are heterogeneous, and the additional expense resulting therefrom is prohibitive.

The tokens that are described in EP 0 533 437 are obtained by a process that can be qualified as mixed in which a resin layer is injection-cast onto a piece that is formed in advance by, for example, cutting up a multilayer sheet. Such a process is expensive because it requires the implementation of an injection-molding installation and means for transfer of the piece toward this installation.

One object of the invention is to propose a process for the production of a token that avoids the bulk of the above-mentioned drawbacks and whose production costs are acceptable.

The invention has as its object a process for the production of a preform for heat-formed containers that come in the form of a token, characterized in that it comprises the stages of:

Production of a lower portion of the token, whereby said production comprises the extrusion of a cylindrical bar and the cutting of said bar into disks,

Production of an upper portion of the token,

Assembly of the two portions of the token to form the token.

According to other characteristics:

The production of the upper portion of the token comprises the co-extrusion of a multilayer sheet and the cutting of said sheet to obtain disks;

The assembly of the two portions of the token is ensured by heat-sealing;

The lower portion of the token is homogeneous and is quite thick and has an orientation in the same direction as the stretching axis of the token;

The upper portion of the token is quite thin;

The multilayer sheet comprises a barrier layer;

The multilayer sheet has an upper layer that is compatible with the protective cap of the heat-formed container;

The multilayer sheet has a lower layer that is modified for heat-sealing on the lower portion of the token.

The invention also has as its object a token that constitutes a preform for the heat-forming of a container, characterized in that it consists of a quite thick, homogeneous lower portion that is obtained by cutting an extruded cylindrical bar and a quite thin upper portion.

According to another characteristic, the upper portion is obtained by cutting up a multilayer sheet that comprises a barrier layer.

Other characteristics emerge from the following description that is given with reference to the accompanying drawing in which:

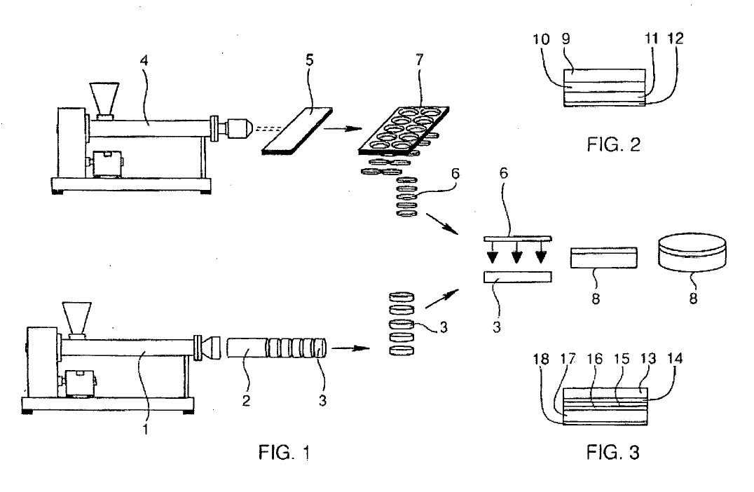

FIG. 1 diagrammatically illustrates the entire process for the production of a token according to the invention;

FIG. 2 shows a cutaway view of the upper portion of a token that is provided for a container that is equipped with a UV barrier;

FIG. 3 shows a cutaway view of the upper portion of a token that is provided for a container that is equipped with a gas barrier.

In FIG. 1, the process for production of tokens is shown diagrammatically. It comprises two parallel branches that are joined in the last stage.

Each of the two branches relates to the production of a portion of the token, and the last stage relates to the assembly of the two portions of the token.

The token actually consists of a lower portion or substrate and is homogeneous and relatively thick, for example with a thickness of 4 mm, and an upper portion or barrier that is heterogeneous and not very thick, for example with a thickness of 1 mm.

The lower portion of the token is obtained in the branch that is shown at the bottom of FIG. 1, and the upper portion of the token is obtained in the branch that is shown at the top of FIG. 1.

The lower portion of the token is obtained by the following stages:

Extrusion by an extruder 1 of a cylindrical bar 2,

Cutting of the cylindrical bar 2 to obtain disks 3 that are designed to each constitute the lower portion of a token.

The upper portion of the token is obtained by the following stages:

Co-extrusion by an extrusion machine 4 of a multilayer sheet 5,

Cutting of the multilayer sheet to obtain disks 6 that are designed to each constitute the upper portion of a token.

The assembly of the two portions of the token is carried out by heat-sealing to result in the token 8, shown in side view and in perspective view.

In FIG. 2, the upper portion 6 of the token consists of four layers, from the top to the bottom:

An upper layer 9 that is compatible with the protective cap of the container that consists of heat-forming of the token,

An anti-UV barrier layer 10, black, for example,

A layer 11 in the same polymer as the lower portion 3 of the token,

A lower layer 12 that is modified for the heat-sealing on the lower portion 3 of the token.

In FIG. 3, the upper portion 6 of the token consists of six layers, from the top to the bottom.

An upper layer 13 that is compatible with the protective cap of the container that consists of heat-forming of the token,

An upper adhesive layer 14,

A gas barrier layer 15,

A lower adhesive layer 16,

A layer 17 in the same polymer as the lower portion 3 of the token,

A lower layer 18 that is modified for heat-sealing on the lower portion 3 of the token.

The various operations for making, on the one hand, the lower portion 3 of the token, and, on the other hand, the upper portion 6 of the token, can be carried out on line at the outlet of the extruder or can be carried out later. The heat-sealing of the two portions of the token can be carried out on line or can be carried out later.

Thus, the token that is designed to constitute a preform of the container to be heat-formed has a lower portion that is quite thick, for example 4 mm, obtained from an extruded cylindrical bar and then cut.

Such a use according to the invention of a process of extrusion for obtaining the lower portion advantageously makes it possible to produce said lower portion virtually without losing material.

Also advantageously, the lower portion of the token that is made from an extruded bar is homogeneous and has an orientation in the extrusion axis, i.e., perpendicular to the mean plane of the token. Such homogeneity and such an orientation cannot be achieved by the processes of injection and cutting into a sheet that are usually used during the production of tokens. In addition, the orientation of the lower portion is in the same direction as the stretching axis of the token during the heat-forming phase, which improves its resistance to the stretching constraints. Whereby the lower portion of the token has a thickness that is clearly greater than the upper portion, it ensures the largest portion of the mechanical resistance of the finished product.

The upper portion of the token, which is quite thin, for example 1 mm, is obtained, after co-extrusion of a multilayer sheet, including a barrier layer, by cutting this sheet. The clippings are limited to the thickness of the upper portion of the token and have an acceptable cost.

The invention was described in a particular embodiment, but the dimensions indicated are given only by way of indication, and variant embodiments, in particular in the structure of the upper portion of the token, can be envisioned without exceeding the scope of the invention.

1. Process for producing a preform for heat-formed containers that comes in the form of a token, characterized in that it comprises the stages of:
Production of a lower portion (3) of the token, whereby said production comprises the extrusion of a cylindrical bar (2) and the cutting of said bar (2) into disks (3),
Production of an upper portion (6) of the token,
Assembly of the two portions of the token to form the token (8).

2. Process according to claim 1, wherein the production of the upper portion (6) of the token comprises the co-extrusion of a multilayer sheet (5) and the cutting of said sheet to obtain disks (6).

3. Process according to claim 1, wherein the assembly of the two portions of the token is ensured by heat-sealing.

4. Process according to claim 1, wherein the lower portion of the token is homogeneous and quite thick and has an orientation in the same direction as the stretching axis of the token.

5. Process according to claim 1, wherein the upper portion of the token is quite thin.

6. Process according to claim 2, wherein the multilayer sheet (5) comprises a barrier layer (10, 15).

7. Process according to claim 2, wherein the multilayer sheet (5) has an upper layer (9, 13) that is compatible with the protective cap of the heat-formed container.

8. Process according to claim 2, wherein the multilayer sheet (5) has a lower layer (12, 18) that is modified for heat-sealing on the lower portion (3) of the token.

9. Token that constitutes a preform for the heat-forming of a container, wherein it consists of a homogeneous lower portion (3) that is quite thick and that is obtained by cutting an extruded cylindrical bar (2) and an upper portion (6) that is quite thin.

10. Token according to claim 9, wherein the upper portion (6) is obtained by cutting up a multilayer sheet (5) that comprises a barrier layer (10, 15).
